(19) United States
(12) Patent Application Publication
(10) Pub. No.: US 2013/0075503 A1
(43) Pub. Date: Mar. 28, 2013

(54) KITCHEN DISPOSER AND METHOD FOR PROCESSING KITCHEN WASTES

(71) Applicant: YA-JYUE CHEN, Taichung City (TW)

(72) Inventor: YA-JYUE CHEN, Taichung City (TW)

(21) Appl. No.: 13/244,543

(22) Filed: Sep. 25, 2011

(51) Int. Cl. B02C 23/18

(52) U.S. Cl. 241/17; 241/65

(57) ABSTRACT

A kitchen disposer includes a basket with a stirring member received within, and a shredding device, and a funnel are installed in a frame. The shredding device and the stirring member are driven by a driving device so as to grind bones and shells of the kitchen wastes into small pieces which are collected in the basket via the funnel. The collected kitchen wastes are mixed with micro-organisms and stirred. By control of the humidity and temperature, the mixture is fermented and becomes fertilizers.

### FIELD OF THE INVENTION

The present invention relates to a disposer, and more particularly, to a kitchen disposer for shredding bones and shells, and a method for processing the kitchen wastes.

### BACKGROUND OF THE INVENTION

The kitchen wastes contain significant amount of water which makes the wastes rotten and attracts flies and mosquitoes. The separation of the kitchen wastes and general garbage can recycle many of the wastes and garbage to reduce the burden of the landfills of the cities. The kitchen wastes can be recycled to reduce the ashes generated during burning. The most common way to reuse the kitchen wastes is to compost the wastes. However, it takes a long time to compost the wastes and may attract flies and mosquitoes during the composting processes. Therefore, a more efficient way to deal with the kitchen wastes is needed.

The conventional kitchen disposer has a blade device which rotates horizontally to crush the kitchen wastes which are hit by the blades and become smaller pieces. The smaller pieces are sent to a tank which rotates to remove the water of the smaller pieces by eccentric force and the de-hydrated pieces are collected to be composted.

However, the conventional disposer has to be cooperated with the tank for removing water from the wastes and a high-speed transportation device so that the cost for the whole set of disposer is high and the structure is complicated. The water removed from the wastes is guided into the sewage system which may not be available in some areas.

The way that the disposer crushes the kitchen wastes cannot crush bones or shells which may be stocked between the blades of the disposer or even break the blades.

If the users do not check the kitchen wastes and which may include iron wastes will damage the disposer.

The present invention intends to provide a compact and less-expensive disposer which can easily crush bones and shells, and the iron wastes can be filtered before shredding.

### SUMMARY OF THE INVENTION

The present invention relates to a kitchen disposer and comprises a basket having a top opening and a stirring member is located within the basket. The stirring member is driven by a driving device and the basket has a door which is located corresponding to a side opening of a frame. A shredding device is connected above the top opening of the basket and has a body and a spiral member. The body has a space in which the spiral member is received. The spiral member has a shaft and multiple triangular plates which are fixedly and spirally mounted to the shaft. Two ends of the shaft protrude from the body and a second passive gear is connected to one of the two ends of the shaft. A funnel is connected above the shredding device. The driving device is connected to and drives the shredding device and the stirring member. A circuit control unit has a control unit, a heater and a fan, wherein the heater is located on outside of the basket and electrically connected with the control unit and the fan. The frame has the side opening and is connected to the basket, the shredding device, the funnel, the driving device and the circuit control unit.

The disposer further comprises a sub-basket having an opening 70 and the stirring member is located in the opening. The basket has a door which is located corresponding to the side opening of the frame. A door plate is located between the basket and the sub-basket which has an overflow hole.

Preferably, the stirring member has a stirring rod and a first passive gear which is located on outside of the basket and connected with the stirring rod. The stirring rod has multiple sub-rods which are located at an angle relative to each other.

Preferably, the space of the body accommodates the spiral member. The body and the spiral member are located above the basket and define an air inlet so that air is sucked by the fan and enters into the basket via the air inlet. The body has multiple holes which are located below the spiral member.

Preferably, the funnel is located above the frame and the top opening of the basket. A magnetic rod is located above the funnel.

Preferably, the driving device comprises a motor and two chains. The motor is electrically connected with the circuit control unit. An active gear is connected to an output shaft of the motor. One of the two chains is connected between the motor and the shredding device. The other chain is connected between the shredding device and the stirring member.

Preferably, the circuit control unit comprises a temperature sensing device and a humidity sensing device and is electrically connected to the control unit. The temperature sensing device and the humidity sensing device sense change of temperature and humidity so as to control the heater and the motor.

Preferably, the circuit control unit has a safety switch.

Preferably, the fan has an active carbon filter net at a front end thereof.

The present invention reduces the volume and weight of the kitchen wastes to be less than 10% of the original volume and weight, and the processed kitchen wastes can be made to be fertilizers.

The spiral member with multiple triangular plates includes multiple spaces which can easily crush and grind the bones and shells.

There is a funnel on the disposer and a magnetic rod is located in the funnel so as to attract iron portions which do not enter into the disposer to protect the disposer.

There is an active carbon filtering net which filters bad smell when the fan is activated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the kitchen disposer of the present invention;

FIG. 2 is an exploded view to show the kitchen disposer of the present invention;

FIG. 3 shows the block diagram of the circuit control unit of the present invention;

FIG. 4 is a front view of the kitchen disposer of the present invention;

FIG. 5 is a side view of the kitchen disposer of the present invention;

FIG. 6 shows the steps of processing the kitchen wastes of the present invention;

FIG. 7 shows that two of the kitchen disposers of the present invention are combined, and

FIG. 8 shows another embodiment of the kitchen disposer of the present invention.

### DETAILED DESCRIPTION OF THE PREFERRED EMBODIMENT

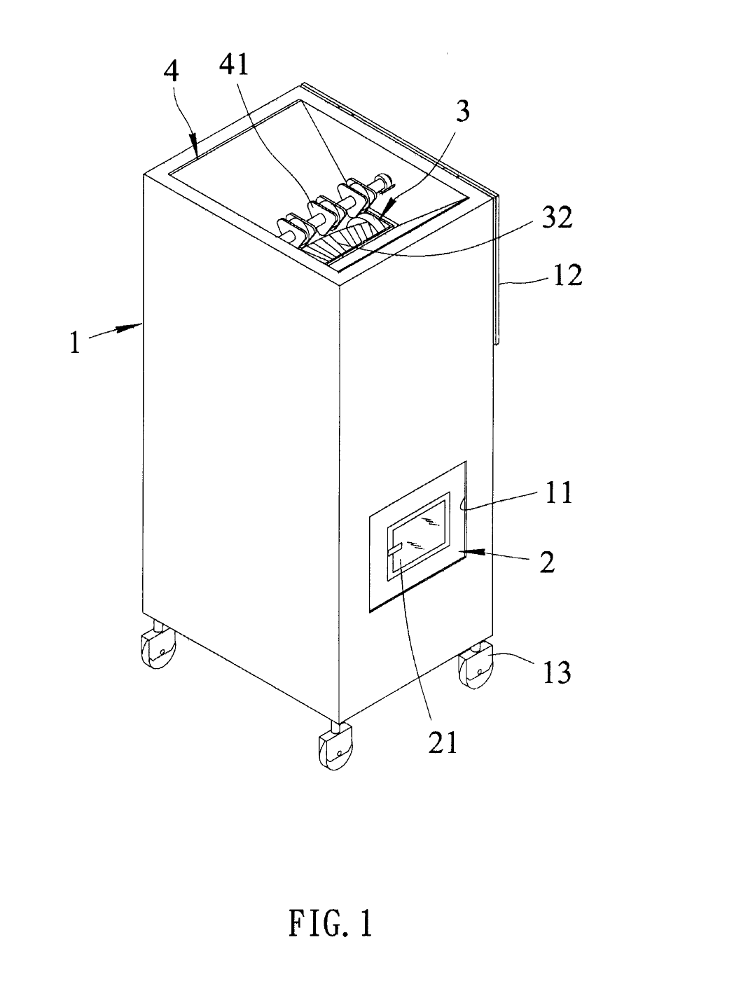

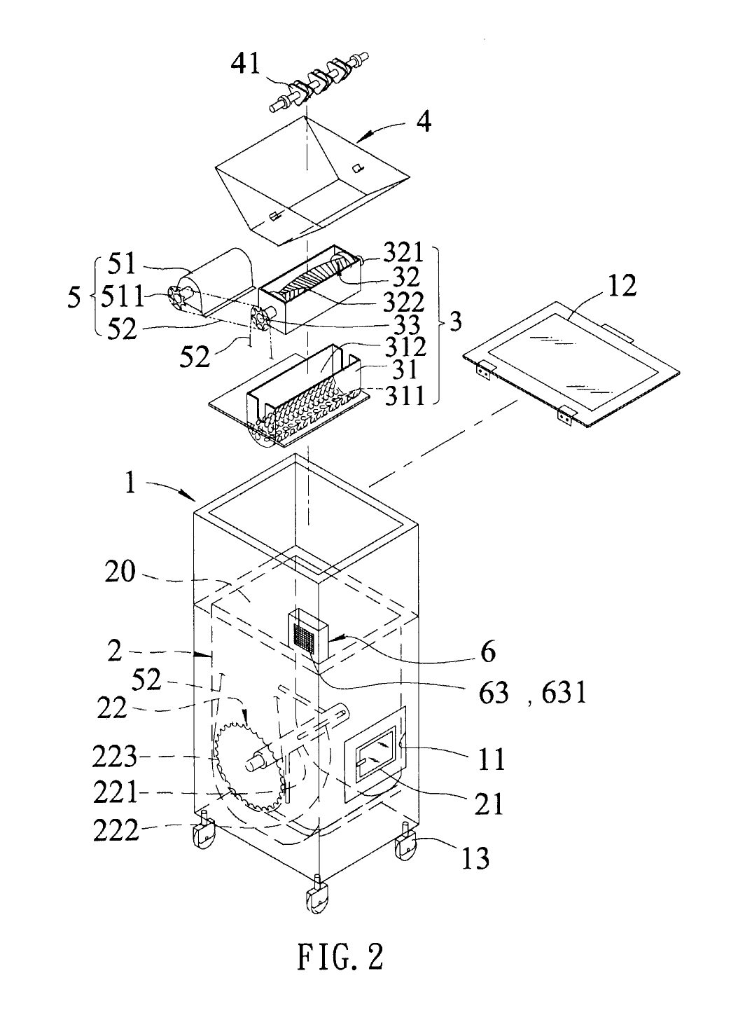

Referring to FIGS. 1 and 2, the kitchen disposer of the present invention comprises a basket 2, a shredding device 3, a funnel 4, a driving device 5, a circuit control unit 6 and a frame 1.

The basket 2 has a top opening 20 and is located in the frame 1. The basket 2 has a door 21 which is located corresponding to a side opening 11 of the frame 1. A stirring member 22 is located within the basket 2 and comprises a stirring rod 221 and a first passive gear 223 which is located on outside of the basket 2 and connected with the stirring rod 221. The stirring rod 221 has multiple sub-rods 222 which are located at an angle relative to each other. When the first passive gear 223 is driven by the driving device 5, the stirring rod 221 and sub-rods 222 are co-rotated.

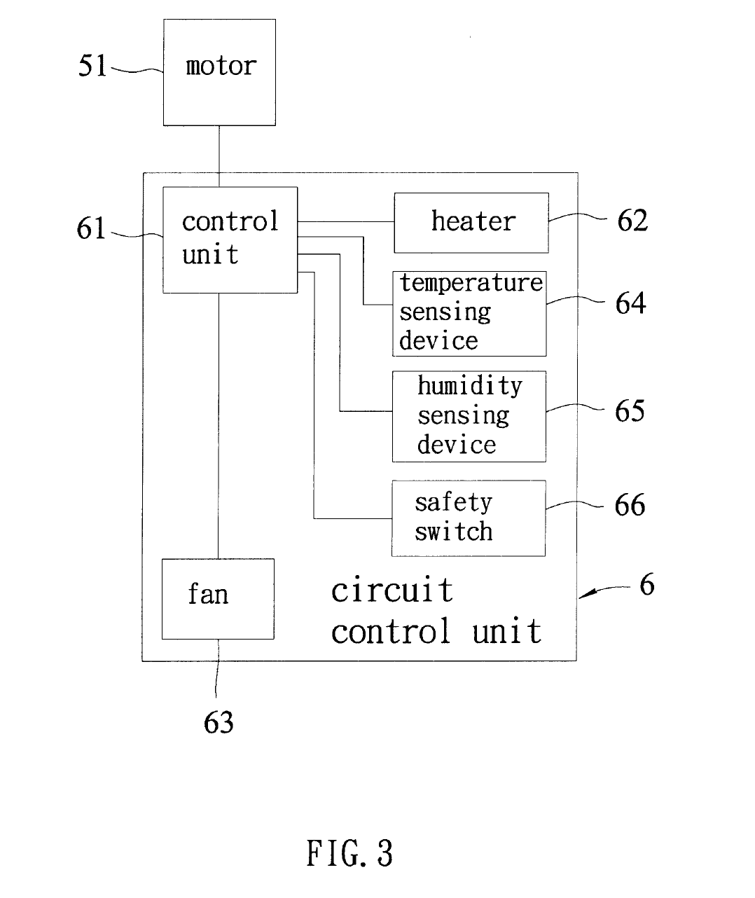

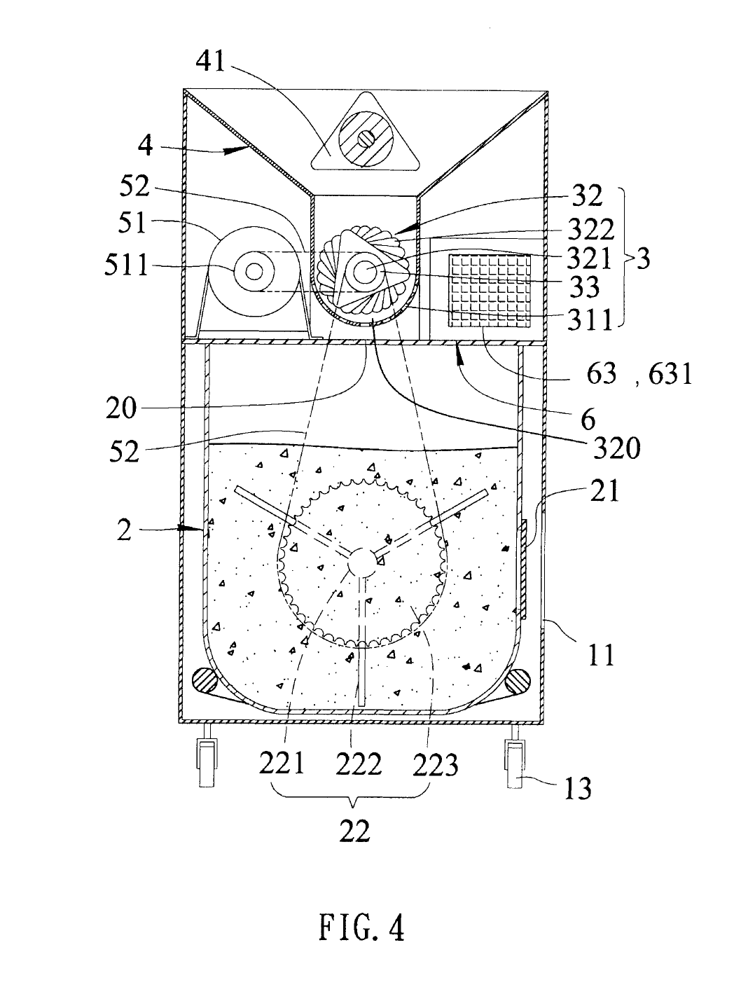

The shredding device 3 is connected above the top opening 20 of the basket 2 and driven by the driving device 5. The shredding device 3 has a body 31 and a spiral member 32, wherein the body 31 having a space 312 defined therein and the spiral member 32 is located in the space 312. The body 31 and the spiral member 32 are located above the basket 2 and cover ⅔ of the top opening 20. The body 31 has multiple holes 311 which are located below the spiral member 32. Referring to FIGS. 3 and 4, the spiral member 32 has a shaft 321 and multiple triangular plates 322 which are fixedly and spirally mounted to the shaft 321. Two ends of the shaft 321 protrude from the body 31 and a second passive gear 33 is connected to one of the two ends of the shaft 321. The second passive gear 33 is driven by the driving device 5 and rotates the spiral member 32.

The funnel 4 is connected above the shredding device 3 and the frame 1. The funnel 4 is located above the top opening 20 of the basket 2. A magnetic rod 41 is located on a top portion of the funnel 4.

The driving device 5 is located on the left side of the shredding device 3 and comprises a motor 51 and two chains 52. The motor 51 is electrically connected with the circuit control unit 6 as shown in FIG. 3, and an active gear 511 is connected to the output shaft of the motor 51. One of the two chains 52 is connected between the motor 51 and the second passive gear 33 of the shredding device 3. The other chain 52 is connected between the shredding device 3 and the first passive gear 223 of the stirring member 22. By the motor 51 driving the active gear 511, the shredding device 3 and the stirring member 22 are activated.

Referring to FIG. 3, the circuit control unit 6 comprises a control unit 61, a heater 62, a fan 63, a temperature sensing device 64, a humidity sensing device 65 and a safety switch 66. The heater 62 is located on outside of the bottom of the basket 2 and electrically connected with the control unit 61, the fan 63, the temperature sensing device 64, and the humidity sensing device 65 so as to grind the kitchen wastes and controls the operation of the temperature and humidity when fermenting. The temperature sensing device 64 and the humidity sensing device 65 sense change of temperature and humidity so as to control the heater 62 and the motor 51. The fan 63 has an active carbon filter net 631 at THE front end thereof. The safety switch 66 has touch-activation switches which are respectively connected to the cover 12 and the door 21. When the cover 12 or the door 21 is opened, the touch-activation switch is cut off, the motor 51 stops. When the cover 12 or the door 21 is closed again, the touch-activation switch is set to be ON, and the motor 51 is activated again.

The frame 1 has a board on the periphery and the bottom and one of the boards has the side opening 11 so that the basket 2, the shredding device 3, the funnel 4, the driving device 5 and the circuit control unit 6 are connected to each other via the side opening 11. The side opening 11 is located corresponding to the door 21 of the basket 2 and the frame 1 has the cover 12. Multiple wheels 13 are connected to the underside of the frame 1.

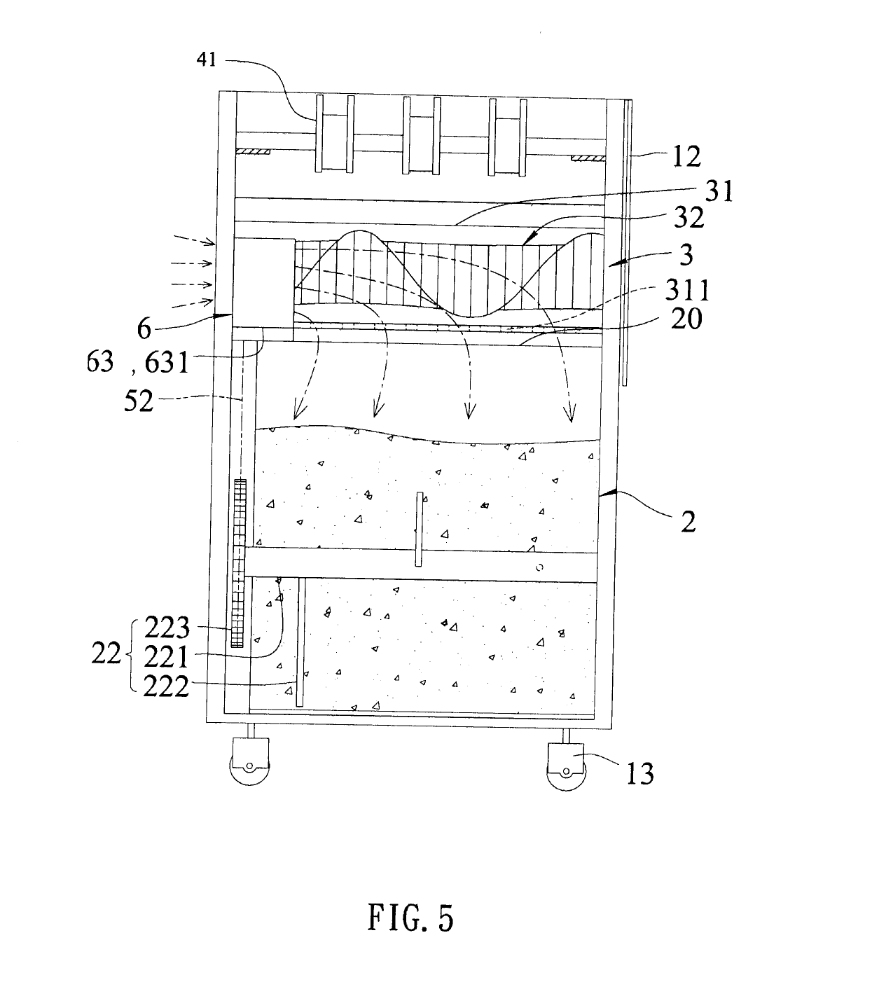

Referring to FIGS. 4 and 5, the frame 1 has the basket 2 in which the stirring member 22 is receive, the shredding device 3 is located above the basket 2 and the funnel 4 is located above the shredding device 3. The funnel 4 has the magnetic rod 41 and the cover 12 is located above the funnel 4. The motor 51 is located on the left side of the shredding device 3 and one of the chains 52 is trained between the active gear 511 of the motor 51 and the second passive gear 33 of the shredding device 3, and the other chain 52 is trained between the second passive gear 33 and the first passive gear 223 of the stirring member 22. The motor 51 drives the shredding device 3 and the stirring member 22, and the body 31 beneath the spiral member 32 has multiple holes 311. The spiral member 32 has multiple triangular plates which define multiple spaces so as to easily crush and grind the bones and shells. The shredding device 3 covers the ⅔ of the basket 2, so as to define an air inlet so that air is sucked by the fan 63 and enters into the basket 2 via the air inlet, and the bad smell cannot escape from the basket 2.

The micro-organisms are stored in the room temperature and are mixed with the kitchen wastes and the micro-organisms are in dormancy status when the temperature is down to minus 30 degrees Celsius. When the kitchen wastes are heated to about 40 degrees Celsius, the micro-organisms are activated. If the kitchen wastes is kept at the temperature about 40 to 50 degrees Celsius, the micro-organisms are more active. Preferably, the micro-organisms are more vigorous when the water content of the kitchen wastes is about 20% to 40%.

Sawdust, the micro-organisms, water are poured in the basket 2 from the funnel 4, the heater 62 of the circuit control unit 6 heats the basket 2 to 40 degrees in Celsius to activate the micro-organisms. The kitchen wastes including bones, shells or even those portion including iron portions are poured into the funnel 4. The magnetic rod 41 attracts the iron portions and the bones and shells are shredded by the shredding device 3. The small pieces of the shredded wastes drop into the basket 2 via the holes 311. The stirring member 22 stirs and mixes the shredded bones, shells, sawdust and the micro-organisms. The fan 63 sucks air into the basket 2. By the temperature sensing device 64, the temperature in the basket 2 is kept at about 40 degrees Celsius.

The way of the stirring of the stirring member 22 is controlled by the control unit 61, the motor 51 activates the stirring member 22 to rotate 2 minutes clockwise, stop 4 seconds, rotate 2 minutes counter clockwise, stop 4 seconds, rotate 2 minutes clockwise, stop 4 seconds, rotate 2 minutes counter clockwise, and stop 25 minutes. The above mentioned stirring pattern is repeated for 2 hours. The disposer then enters the energy-saving mode to allow the micro-organisms to ferment. When the humidity sensing device 65 detects that the contents of water is less than 10%, which means the fermenting process is completed, the heater 62 automatically stops (the heater stops when the temperature is over 50 degrees Celsius). The fermentation makes the kitchen wastes become organic fertilizers which is only 10% of the volume and weight of the kitchen wastes. The organic fertilizers do not include water and grease.

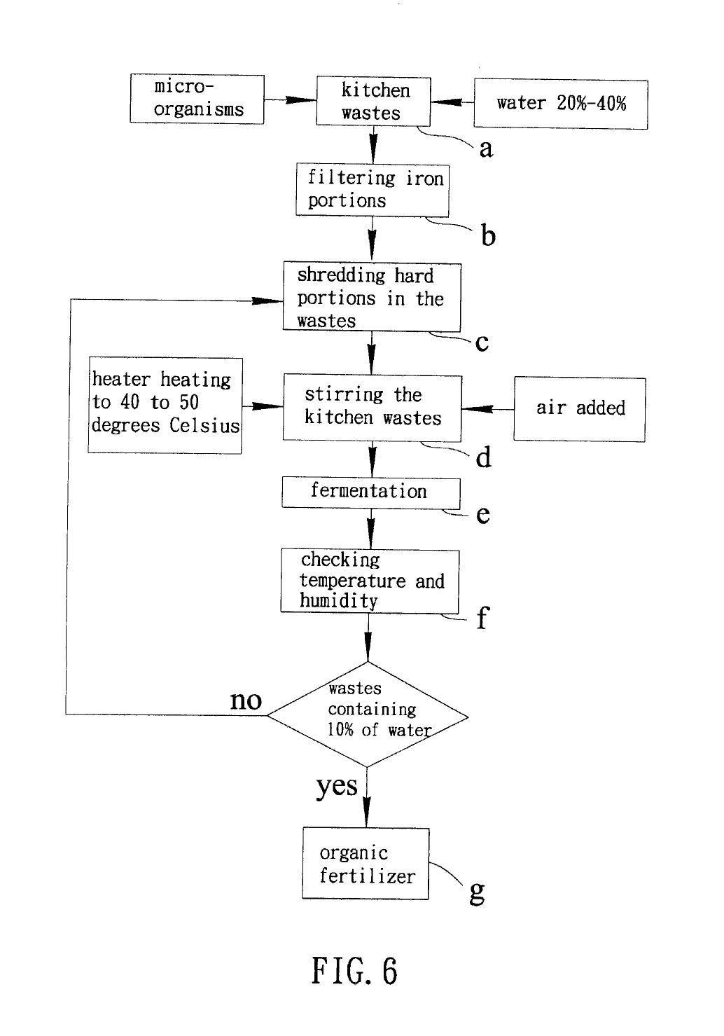

Referring to FIG. 6, the method for processing kitchen wastes of the present invention comprises:

step (a) mixing micro-organism, kitchen wastes and water (20% to 40%);

step (b) filtering the iron components out from the kitchen wastes;

step (c) shredding the kitchen wastes;

step (d) adding air and stirring the kitchen wastes, heating the kitchen wastes to 40 to 50 degrees Celsius;

step (e) fermenting the kitchen wastes at the temperature between 40 to 50 degrees Celsius until only 10% of water left, and

step (f) forming organic fertilizer.

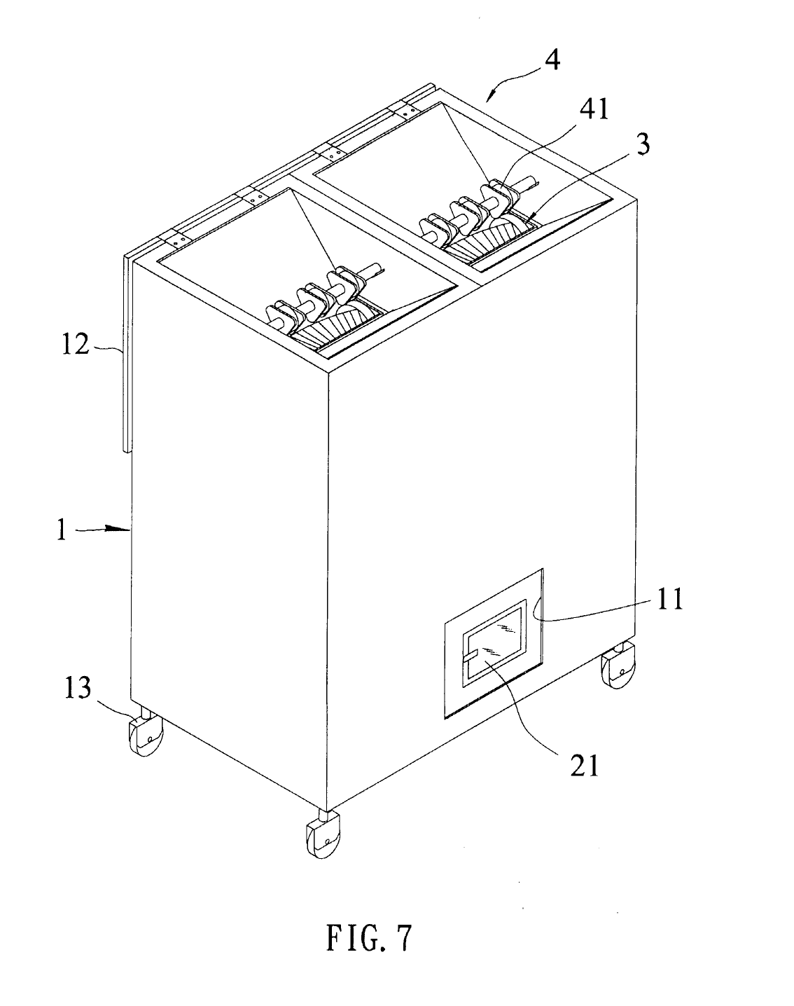

FIG. 7 shows that two disposers of the present invention are combined as one to increase the efficiency of fermentation.

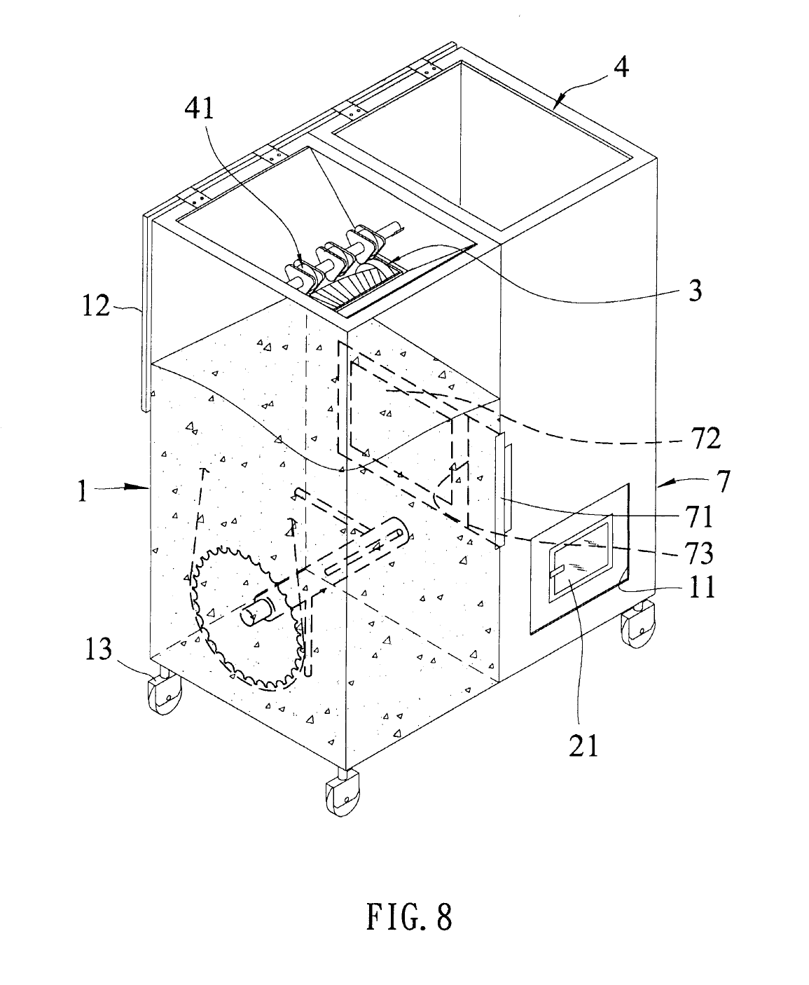

FIG. 8 shows that the basket 2 has a sub-basket 70 which has an opening 70. A slot and a port 73 are connected between the sub-basket 7 and the basket 2. A door plate 71 is engaged with the slot and located between the basket 2 and the sub-basket 7. The door plate 71 has an overflow hole 72. The extra kitchen wastes that are over the overflow hole 72, the kitchen wastes will drop into the sub-basket 7 via the in the overflow hole 72. The door plate 71 can also be pulled out if the overflow hole 72 is not large enough, so that the extra kitchen wastes directly enter the sub-basket 7 via the port 73 which is larger than the overflow hole 72. Although the kitchen wastes are fermented for 24 hours by the method and the disposer of the present invention, and half of kitchen wastes become organic fertilizer, in order to dehydrate the fertilizer, the fertilizer fermented for 24 hours that fills about 80% of the basket 2 can be removed to the sub-basket 7 via the door plate 71, so that each of the basket 2 and the sub-basket 7 have half of the fertilizer. The two baskets 2, 7 are then left for 72 hours and the micro-organisms continue to ferment so as to form organic fertilizer in the two basket 2, 7 completely.

While we have shown and described the embodiment in accordance with the present invention, it should be clear to those skilled in the art that further embodiments may be made without departing from the scope of the present invention.

What is claimed is:

1. A kitchen disposer comprising:
a basket having a top opening and a stirring member located within the basket, the stirring member being driven by a driving device, the basket having a door which is located corresponding to a side opening of a frame;
a shredding device connected above the top opening of the basket and having a body and a spiral member, the body having a space defined therein and the spiral member located in the space, the spiral member having a shaft and multiple triangular plates which are fixedly and spirally mounted to the shaft, two ends of the shaft protruding from the body and a second passive gear connected to one of the two ends of the shaft;
a funnel connected above the shredding device;
the driving device connected to and driving the shredding device and the stirring member;
a circuit control unit having a control unit, a heater and a fan, the heater located on outside of the basket and electrically connected with the control unit and the fan, and
the frame having the side opening and connected to the basket, the shredding device, the funnel, the driving device and the circuit control unit.

2. The disposer as claimed in claim 1 further comprising a sub-basket having an opening and the stirring member located in the opening, the basket having a door which is located corresponding to the side opening of the frame, a door plate located between the basket and the sub-basket, the door plate having an overflow hole.

3. The disposer as claimed in claim 1, wherein the stirring member has a stirring rod and a first passive gear which is located on outside of the basket and connected with the stirring rod, the stirring rod has multiple sub-rods which are located at an angle relative to each other.

4. The disposer as claimed in claim 1, wherein the space of the body accommodates the spiral member, the body and the spiral member are located above the basket and define an air inlet so that air is sucked by the fan and enters into the basket via the air inlet, the body has multiple holes which are located below the spiral member.

5. The disposer as claimed in claim 1, wherein the funnel is located above the frame and the top opening of the basket, a magnetic rod is located above the funnel.

6. The disposer as claimed in claim 1, wherein the driving device comprises a motor and two chains, the motor is electrically connected with the circuit control unit, an active gear is connected to an output shaft of the motor, one of the two chains is connected between the motor and the shredding device, the other chain is connected between the shredding device and the stirring member.

7. The disposer as claimed in claim 6, wherein the circuit control unit comprises a temperature sensing device and a humidity sensing device and is electrically connected to the control unit, the temperature sensing device and the humidity sensing device sense change of temperature and humidity so as to control the heater and the motor.

8. The disposer as claimed in claim 1, wherein the circuit control unit has a safety switch.

9. The device as claimed in claim 1, wherein the fan has an active carbon filter net at a front end thereof.

10. A method for processing kitchen wastes comprising:
step (a) mixing micro-organism, kitchen wastes and water (20% to 40%);
step (b) filtering the iron components out from the kitchen wastes;
step (c) shredding the kitchen wastes;
step (d) adding air and stirring the kitchen wastes, heating the kitchen wastes to 40 to 50 degrees Celsius;
step (e) fermenting the kitchen wastes until only 10% of water left, and step (f) forming organic fertilizer.
